(19) United States
(12) Patent Application Publication
(10) Pub. No.: US 2013/0297576 A1
(43) Pub. Date: Nov. 7, 2013

(54) EFFICIENT IN-PLACE PRESERVATION OF CONTENT ACROSS CONTENT SOURCES

(71) Applicants: Quentin Gary Christensen, Redmond, WA (US); Michal Piaseczny, Issaquah, WA (US); John D. Fan, Redmond, WA (US); Julian Zbogar Smith, Redmond, WA (US); Benjamin Joseph Rinaca, Seattle, WA (US); Ramanathan Somasundaram, Bothell, WA (US); Graham Lee McMynn, Redmond, WA (US); Adam David Harmetz, Seattle, WA (US); Jessica Anne Alspaugh, Seattle, WA (US); Bradley Stevenson, Seattle, WA (US); Sridharan Ramanathan, Kirkland, WA (US); Tudor Baraboi, Seattle, WA (US); Thottam R. Sriram, Redmond, WA (US); Zainal Arifin, Redmond, WA (US); Yingtao Dong, Redmond, WA (US); Sarosh Anwar, Redmond, WA (US); Anupama Janardhan, Seattle, WA (US); Ashish Shrikrishna Malgi, Redmond, WA (US); Khoj M. Ladha, Sammamish, WA (US)

(72) Inventors: Quentin Gary Christensen, Redmond, WA (US); Michal Piaseczny, Issaquah, WA (US); John D. Fan, Redmond, WA (US); Julian Zbogar Smith, Redmond, WA (US); Benjamin Joseph Rinaca, Seattle, WA (US); Ramanathan Somasundaram, Bothell, WA (US); Graham Lee McMynn, Redmond, WA (US); Adam David Harmetz, Seattle, WA (US); Jessica Anne Alspaugh, Seattle, WA (US); Bradley Stevenson, Seattle, WA (US); Sridharan Ramanathan, Kirkland, WA (US); Tudor Baraboi, Seattle, WA (US); Thottam R. Sriram, Redmond, WA (US); Zainal Arifin, Redmond, WA (US); Yingtao Dong, Redmond, WA (US); Sarosh Anwar, Redmond, WA (US); Anupama Janardhan, Seattle, WA (US); Ashish Shrikrishna Malgi, Redmond, WA (US); Khoj M. Ladha, Sammamish, WA (US)

(73) Assignee: MICROSOFT CORPORATION, Redmond, WA (US)

(21) Appl. No.: 13/462,825

(22) Filed: May 3, 2012

(51) Int. Cl. G06F 7/00; G06F 17/30

(52) U.S. Cl. 707/695; 707/E17.005

(57) ABSTRACT

Technologies are described herein for providing efficient in-place preservation of content in multiple, disparate content sources without disrupting end-users' access to the content or content sources. A preservation request comprising a specification of a content source and a filter specification is received and the content source is marked as “on hold.” If a content item in the content source is modified or deleted, a copy of the current version of the content item is placed in a preservation storage area. A trim job may be run periodically that removes content items from the preservation storage area that do not match the filter specification.

### BACKGROUND

A company involved in litigation may be obligated to locate and disclose all relevant “evidence” to opposing counsel. Such evidence may include a variety of electronic content, including email messages, documents and files, list and other contents maintained on websites, and the like, spread across disparate contents source systems including on premise (local) and cloud-based servers. Content in these content source systems related to the litigation is often placed “on hold” or preserved for later retrieval and analysis. The amount of data preserved may be vast, and locating and preserving the relevant electronic content across the disparate systems may need to be performed without disrupting end-users' access to the content or the content sources.

It is with respect to these considerations and others that the disclosure made herein is presented.

### SUMMARY

Technologies are described herein for providing efficient in-place preservation of content in multiple, disparate content sources without disrupting end-users' access to the content or content sources. Utilizing the technologies described herein, various content items in disparate content sources deemed relevant to a business issue or event may be preserved as of a particular date for later retrieval and analysis. The preservation may be performed in-place so that duplicate storage of content items is minimized or eliminated without limiting end-users' ability to access or modify the content items. Moreover, the in-place preservation may allow the preserved content items to be indexed and searched by appropriate personnel involved in the business issue or event utilizing the security and services provided by the content source system while the preserved versions of the content items remain hidden to the end-users.

According to embodiments, a content server receives a preservation request comprising a specification of a content source hosted on the content server and a filter specification. The content server may mark the specified content source as “on hold” by creating a hold specification related to the content source. If the content server detects that a content item has been modified or deleted in a content source that is on hold, the content server places a copy of the current version of the content item into a preservation storage area. The preservation storage area may be a hidden area in the content source, for example. The content server may then periodically run a trim job that removes content items from the preservation storage area that do not match the filter specification.

It will be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1 and 2 are block diagrams showing aspects of an illustrative operating environment and software components provided by the embodiments presented herein;

FIG. 3 is a flow diagram showing one method for providing efficient in-place preservation of content in multiple, disparate content sources without disrupting end-users' access to the content or content sources, according to embodiments described herein;

FIG. 4 is a flow diagram showing one method for periodically removing content items from a preservation storage area, according to embodiments described herein;

FIG. 5 is a block diagram showing an illustrative computer hardware and software architecture for a computing system capable of implementing aspects of the embodiments presented herein; and

FIG. 6 is a block diagram illustrating a distributed computing environment capable of implementing aspects of the embodiments presented herein.

### DETAILED DESCRIPTION

The following detailed description is directed to technologies for providing efficient in-place preservation of content in multiple, disparate content sources without disrupting end-users' access to the content or content sources. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof and that show, by way of illustration, specific embodiments or examples. In the accompanying drawings, like numerals represent like elements through the several figures.

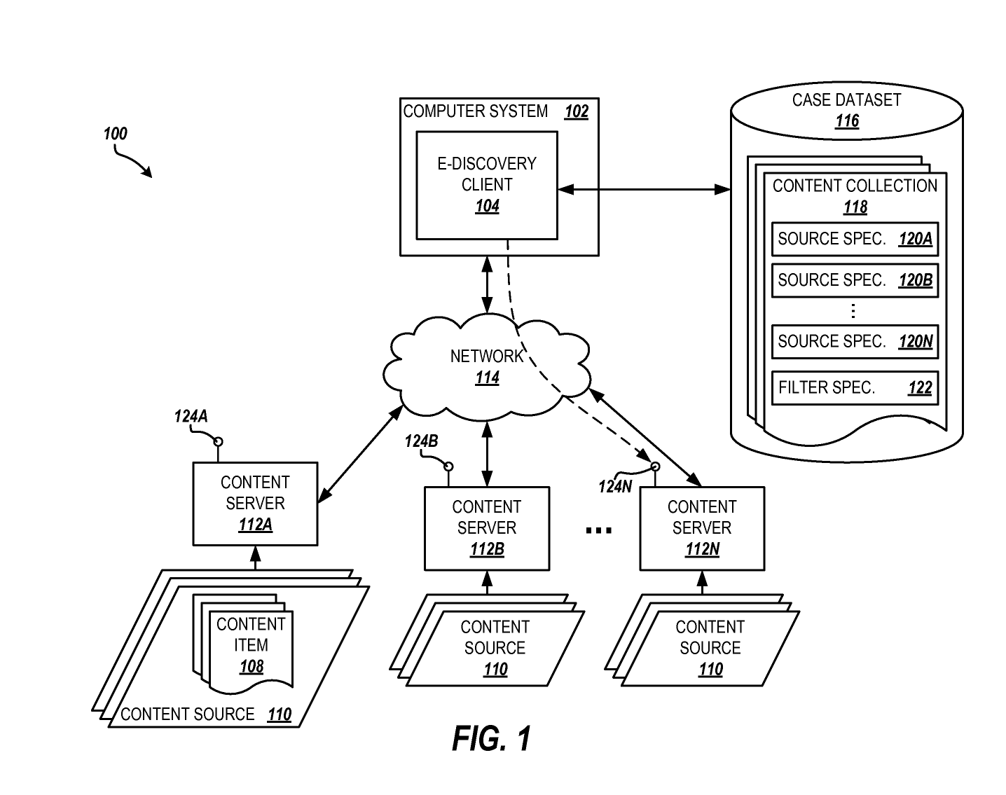

FIG. 1 shows an illustrative operating environment 100 including software components for providing efficient in-place preservation of content in multiple, disparate content sources without disrupting end-users' access to the content or content sources, according to embodiments provided herein. The environment 100 includes a computer system 102. In one embodiment, the computer system 102 represents a user computing device, such as a personal computer (“PC”), a desktop workstation, a laptop, a notebook, a tablet, a mobile device, a personal digital assistant (“PDA”), a game console, a set-top box, a consumer electronics device, and the like. In other embodiments, the computer system 102 may represent one or more Web and/or application servers executing web-based application programs and accessed over a network 114 by a user using a Web browser or other client application executing on a user computing device.

An e-discovery client 104 may execute on the computer system 102. In one embodiment, the e-discovery client 104 may be a component of a larger e-discovery application that may be utilized by a user to identify and preserve a set of content items relevant to a business issue or event, such as litigation or other legal matters, for example. The e-discovery client 104 may allow the user to utilize targeted search queries to locate relevant content items from a “virtual archive” comprising content items 108 stored in multiple content sources 110. Examples of a content source 110 may include an email mailbox, a document library, a fileshare, a discussion thread, a Web log (“blog”), a website, and the like. Examples of content items 108 may include email messages, documents or files, webpages, an entry in a discussion thread, a blog post, a wiki page entry, and the like.

According to embodiments, the content items 108 may be hosted by, stored on, and/or accessed through multiple, disparate content servers 112A-112N (also referred to herein generally as content servers 112 or content server 112). The e-discovery client 104 may access the content servers 112 over a network 114. The network 114 may be a local-area network (“LAN”), a wide-area network (“WAN”), the Internet, or any other networking topology known in the art that connects the computer system 102 to the content servers 112. The content servers 112 may include local servers located in the same location or on the same corporate LAN/WAN as the computer system 102, as well as cloud-based server resources accessed by the e-discovery client 104 over the Internet.

In one embodiment, the content servers 112 include one or more email servers, such as MICROSOFT® EXCHANGE SERVER email servers from Microsoft Corporation of Redmond, Washington. The content servers 112 may also include one or more content site servers, such as MICROSOFT® SHAREPOINT® servers, also from Microsoft Corporation. The content servers 112 may also include one or more file servers, NAS storage devices, or other file and document storage systems. In other embodiments, the content servers 112 may include document management servers, database servers, Web servers, and other data and content servers known in the art.

The e-discovery client 104 may access a case dataset 116 that defines the various content sources 110 containing the content items 108 comprising the virtual archive of items to be located and preserved. The case dataset 116 may represent an XML file, one or more database tables in a database, or any other structured storage mechanism known in the art stored on or accessible to the computer system 102. The case dataset 116 may contain one or more content collections 118, each content collection 118 comprising one or more source specifications 120A-120N (also referred to herein as source specifications 120 or source specification 120).

Each source specification 120 may identify a specific content source 110 containing content items 108 that collectively make up the virtual archive. For example, one source specification 120A may identify a specific email mailbox hosted on an email server. Another source specification 120B may identify a document library accessed through a content site server hosting a content site. In other embodiments, a source specification may specify the entire content site, which may include multiple sub-sites, one or more document libraries, web pages, wikis, blogs, publishing pages, and items lists, such as tasks, status, and microblogs. Organizing the source specifications 120 into content collection(s) 118 may allow configuration options for the virtual archive to be applied at a content collection level, such as whether content items 108 are to be preserved in place or in an external archive, how duplicate content items will be handled during export, whether multiple versions of the content items will be exported when available, and the like.

A content collection may further include a filter specification 122. The filter specification 122 may provide parameters for further limiting the content items 108 contained in the source specifications 120 that are deemed to be relevant content items. According to embodiments, the filter specification 122 may include a date-range for email messages sent or documents created or modified, one or more keywords or search expressions for filtering the content items, author/sender of documents or email messages, and/or the like. In further embodiments, filters specifications 122 may be specified at a content source level, i.e. per source specification 120, or for the entire virtual archive defined in the case dataset 116.

The e-discovery client 104 may request the preservation of the content items 108 as defined by the source specifications 120 and filter specifications 122 in the case dataset 116 through a preservation interface 124A-124N (also referred to herein as preservation interfaces 124 or preservation interface 124) exposed by each content server 112A-112N containing specified content items. For example a content server 112A comprising an email server may provide a preservation interface 124A allowing the e-discovery client to specify one or more source specifications 120 (email mailboxes) in which the content items 108 (email message) are to be preserved as of a particular date (referred to herein as the “preservation date”). The preservation interfaces 124 may comprise SOAP-based Web services, Java RMI calls, WINDOWS® communication foundation (“WFC”) services, or any combination of these and other interfaces known in the art.

The preservation interface 124 for the content server 112A may further allow the filter specification 122 to be specified to further limit the content items 108 in the specified sources specifications 120 to be preserved as of the preservation date. Each content server 112 may effect preservation of the corresponding content items 108 in a different fashion. According to embodiments, content servers 112, such as the MICROSOFT® EXCHANGE SERVER email server or the MICROSOFT® SHAREPOINT® server, may implement an in-place preservation mechanism that minimizes the storage space required for preservation without limiting end-users' ability to access or modify the content items 108, as will be described below.

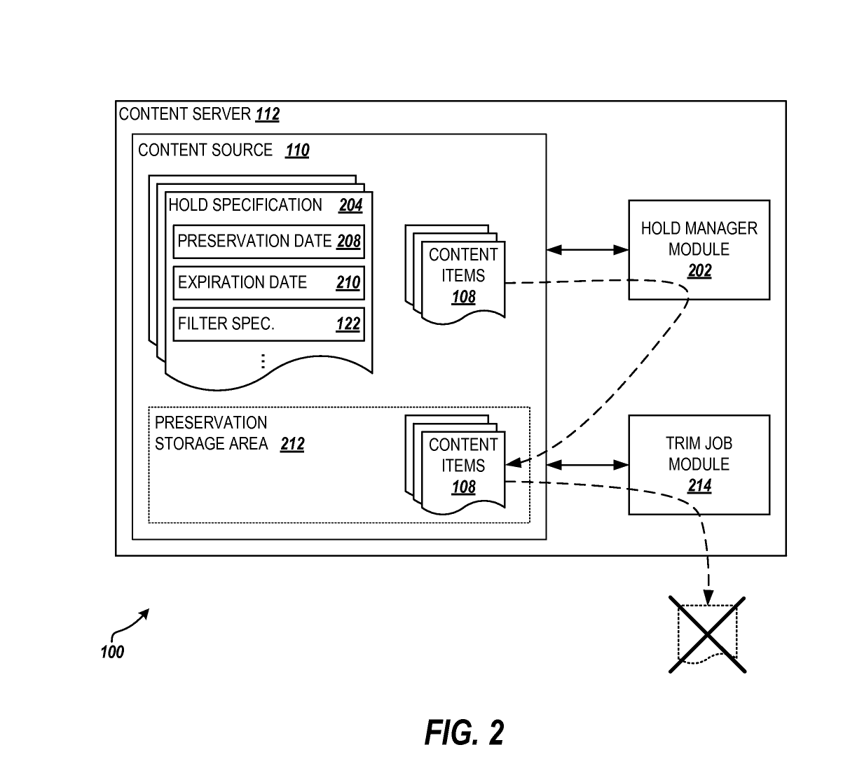

FIG. 2 shows further details of the operating environment 100 in regard to a content server 112 implementing the in-place preservation mechanism described herein, according to embodiments. As described above, the content server 112 may receive a preservation request specifying a list of content sources 110, such as email mailboxes, content sites, document libraries, fileshares, discussion threads, lists, web pages, and the like, hosted by the content server in which content items 108 are to be preserved. The preservation request may be received from the e-discovery client 104 through the preservation interface 124 of the content server 112, for example, or from other external or internal applications. The content server 112 may execute a hold manager module 202 that processes the preservation request. The hold manager module 202 may be implemented in hardware, software, or some combination of these. The hold manager module 202 may further comprise a combination of different modules or components implemented on the content server 112.

The hold manager module 202 may mark the content sources 110 specified in the preservation request as “on-hold” by creating a hold specification 204 related to each content source 110. In some embodiments, the hold specification 204 comprises a flag or other attribute of the content source 110 indicating that the content source 110 has been placed on-hold. In further embodiments, the hold specification 204 may additionally store parameter values regarding the preservation request received at the content server 112. According to one embodiment the hold specification 204 may be created for each content source 110 and stored with the content source. For example, a hold specification 204 may be created for an individual email mailbox hosted by an email server and stored in the metadata for the email mailbox.

In another embodiment, the hold specification 204 may be created for a higher level storage container containing the content source 110. For example, for a specified content source 110 comprising a document library, the hold specification 204 may be created for the entire content site containing the document library and stored as metadata describing the content site. In further embodiments, the hold specification 204 may be created in a database, file, or other storage system implemented by or accessible to the content server 112 and related to the content source 110 hosted by the content server through a source specification 120. In addition, a single hold specification 204 may be related to multiple content sources 110 through multiple source specifications 120. For example, an email server may store a list of hold specifications 204, each of which specifies a list of email mailboxes to which the corresponding preservation request or “hold” applies.

The hold specification 204 may include a preservation date 208 indicating the date as of which content items 108 in the related content source 110 are to be preserved. According to some embodiments, the preservation date 208 may be specified in the parameters of the preservation request received from the e-discovery client 104. In other embodiments, the preservation date 208 may be defaulted to the date that the preservation request was received, for example. The hold specification 204 may also include an expiration date 210 indicating a date after which preserved versions of content items 108 that have been deleted or modified by end-users may be purged. As in the case of the preservation date 208, the expiration date 210 may be specified in the parameters of the preservation request received from the e-discovery client 104, or the expiration date 210 may be set to a value in order for the items to be preserved for some default period of time. In one embodiment, the expiration date 210 may default to a max date value, indicating that the content items 108 in the related content source 110 are to be preserved indefinitely.

The hold specification 204 may further include the filter specification 122 provided by the e-discovery client 104 in the preservation request. As described above in regard to FIG. 1, the filter specification 122 may specify keywords and/or a date-range that further limits the content items 108 of the related content source 110 to be preserved. It will be appreciated that the hold specification 204 may include additional or different parameter values than shown in FIG. 2 and described above that is used by the hold manager module 202 to preserve the content items 108 in the content source. It will be further appreciated that a particular content source 110 may be related to multiple hold specifications 204 created for different preservation requests and containing different preservation dates 208, expiration dates, filter specifications 122, and/or other parameters.

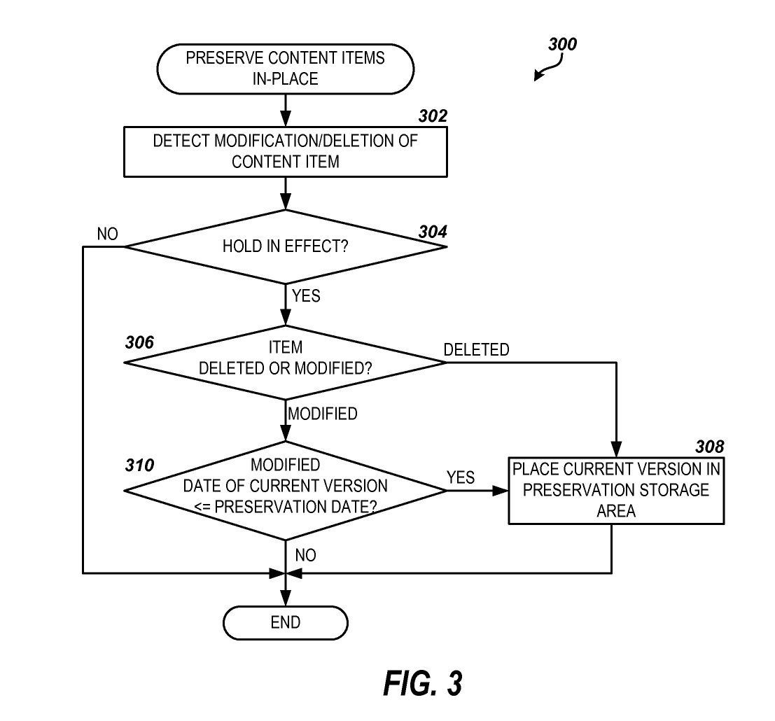

The hold manager module 202 may utilize the parameter values included in the hold specification 204 to effect preservation of the content items 108 contained in the related content source 110 as of the specified preservation date 208. For example, as will be described in more detail below in regard to FIG. 3, the hold manager module 202 may detect a pending change to a content item 108 in the content source 110, such as a deletion of the item or a modification of its content. Upon detecting the changes, the hold manager module 202 may move a copy of the current version of the content item 108 to a preservation storage area 212 in order that the content item of the preservation date 208 may be preserved.

According to some embodiments, the preservation storage area 212 may represent an area of the content source 110 in which the preserved versions of the content items 108 may be stored in such a way that they are hidden to the end-user of the content source but remain accessible by appropriate personnel involved in the business issue or event. For example, for a content source 110 comprising an email mailbox on an email server, the preservation storage area 212 may comprise a hidden folder in the email mailbox. Email messages deleted from the email mailbox may instead be moved to the hidden folder. Messages stored in the hidden folder may be inaccessible to the mailbox user, but may be indexed by the email server and searchable and accessible by other personnel through appropriate security settings on the email server.

In other embodiments, the preservation storage area 212 may represent an area of the higher level storage container in which the content source 110 is contained. For example, for a content source 110 comprising a document library, the preservation storage area 212 may comprise a separate, hidden document library in the content site containing the document library. If a document in the document library is modified, the current version of the document may be stored in the hidden document library. As in the case of the email mailbox described above, documents stored in the hidden document library may be inaccessible to end-users of the content site, but may be indexed by the content site server and made searchable and accessible by other personnel through appropriate security settings on the content site server. It will be appreciated that by storing only those content items 108 that are deleted or modified in the preservation storage area 212, the amount of storage space required to effect preservation of the content items in the content source 110 is minimal in comparison to that required by a traditional snapshot archive of the content source taken on the preservation date.

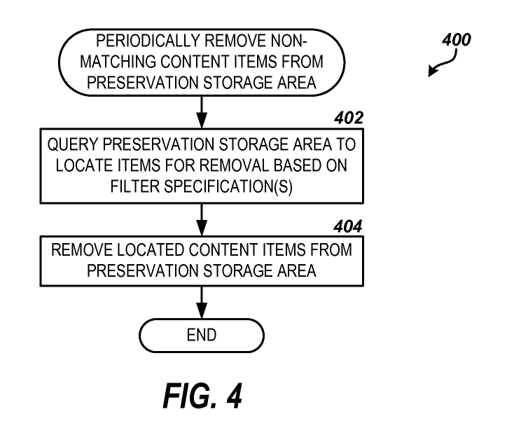

In further embodiments, the content server 112 may execute a trim job module 214. As will be described in more detail below in regard to FIG. 4, the trim job module 214 may periodically run and remove items from the preservation storage area 212 based on the filter specification 122 in any active hold specification(s) 204 related to the content source 110. This may be done to remove those content items that are not relevant to the preservation request, thus further reducing the amount of storage space required for the preservation of the content items 108 in the content source 110. The trim job module 214 may be implemented in hardware, software, or some combination of these. The trim job module 214 may further comprise a combination of different modules or components implemented on the content server 112.

Referring now to FIGS. 3 and 4, additional details will be provided regarding the embodiments presented herein. It will be appreciated that the logical operations described with respect to FIGS. 3 and 4 are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It will also be appreciated that more or fewer operations may be performed than shown in the figures and described herein. The operations may also be performed in a different order than described.

FIG. 3 illustrates one routine 300 for providing efficient in-place preservation of content in multiple, disparate content sources without disrupting end-users' access to the content or content sources, according to one embodiment. The routine 300 may be performed by the hold manager module 202 executing on the content server 112, for example. It will be appreciated that the routine 300 may also be performed by other modules or components executing on the content server 112, or by any combination of modules, components, and computing devices. The routine 300 begins at operation 302, where the hold manager module 202 detects a modification or deletion of a content item 108 in a content source 110 hosted by the content server. For example, the hold manager module 202 may detect that an email message is being purged from a deleted items folder or other folder in an email mailbox, or that a document in a document library is being modified by an end user.

The routine 300 proceeds from operation 302 to operation 304, where the hold manager module 202 determines if a hold is in effect for the content source 110 containing the content item 108. This may be accomplished by checking a particular flag or attribute of the content source 110 or by determining if a hold specification 204 related to the content source 110 exists in the metadata defining the content source or a higher level storage container, for example. If no hold is in effect for the content source 110 containing the content item 108, then the routine 300 ends, and the deletion or modification of the content item proceeds as normal.

However, if a hold is in effect for the content source, the routine 300 proceeds from operation 304 to operation 306, where the hold manager module 202 determines if the content item 108 is being deleted or modified. If the content item 108 is being deleted, then the routine 300 proceeds to operation 308, where the hold manager module 202 places the current version of the content item 108 in the preservation storage area 212. This may entail simply moving the content item 108 to the preservation storage area 212 in lieu of deleting the content item from content source 110, or a copy of the content item 108 may be placed in the preservation storage area before allowing the deletion of the content item to proceed as normal. In other embodiments, if the content item 108 being deleted is a document for which multiple versions exist in a document library, for example, all of the stored versions of the document may be moved to the preservation storage area. From operation 308, the routine 300 then ends.

If, at operation 306, it is determined that the content item 108 is being modified, then the routine 300 proceeds to operation 310, where the hold manager module 202 determines if the modified date of the current version of the content item 108 is less than the preservation date 208 specified in the hold specification 204 related to the content source 110. If the modified date of the current version of the content item 108 is less than or equal to the preservation date 208, then the routine 300 proceeds to operation 308, where the hold manager module 202 places the current version of the content item 108 in the preservation storage area 212 before the item is updated in the content source 110. From operation 308, the routine 300 then ends.

If, at operation 310, the modified date of the current version of the content item 108 is not less than or equal to the preservation date 208, then the routine 300 ends, and the content item 108 is updated without placing a copy of the item in the preservation storage area 212. Performing the check of the modified date in relation to the preservation date 208 allows for only one version of the content item 108—the version that existed as of the preservation date—to be stored in the preservation storage area 212, further reducing the amount of storage space required to effect preservation of the content items 108 in the content source.

It will be appreciated that if multiple holds are in effect for the content source 110, i.e. multiple hold specifications 204 related to the content source exist, then the hold manager module 202 may check the modified date of the current version of the content item 108 against the latest preservation date 208 from all of the related hold specifications in order to determine if a copy of the content item is to be placed in the preservation storage area 212. In another embodiment, the hold manager module 202 may always place the current version of the content item 108 in the preservation storage area 212 upon the content item being deleted or modified, regardless of the modified date of the current version. In some embodiments, the hold manager module 202 may further only place a copy of the content item 108 into the preservation area if the content item matches the filter specification 122.

According to some embodiments, when placing the current version of the content item 108 into the preservation storage area 212, the hold manager module 202 may ensure that metadata regarding that version of the content item is preserved as well. For example, for a content item 108 comprising a document in a document library, the current version of the document may be placed into the preservation storage area 212 along with metadata describing the creation date of the document, the last modified date, the author, the version number or name, and the like. The original location of the content item 108 in the content source 110, such as the particular document library or the folder containing the item in the email mailbox, may be preserved in the metadata as well, in order for any manifest created during the export of the preserved content items from the content sources to show the original location as the location for the exported content item instead of the hidden preservation storage area 212.

In further embodiments, if the content item 108 being modified or deleted is an individual item in a content source 110 comprising a list of items, such as a post in a discussion thread, an entry in a wiki page, or a post in a blog, for example, the hold manager module 202 may place the current version of the entire list in the preservation storage area 212 before the deletion or modification of the individual list item occurs. Similarly, the hold manager module 202 may place an entire container, such as a folder, containing the content item 108 in the preservation storage area 212 before the deletion or modification of the individual content item occurs. In other embodiments, the hold manager module 202 may employ a file or document naming scheme to handle situations where multiple copies or different versions of the same content item 108 are placed in the preservation storage area 212. For example, the hold manager module 202 may rename the content items 108 moved to the preservation storage area 212 using the following format:
<OriginalFileName>_<OriginalUniqueID>_<Version>.<OriginalExtension>

FIG. 4 illustrates one routine 400 for periodically removing content items 108 from the preservation storage area 212 of a content source 110 in order to further reduce the storage space required for preserving the content items 108 based on a preservation request. The routine 400 may be performed by the trim job module 214 executing on the content server 112, for example. It will be appreciated that the routine 400 may also be performed by other modules or components executing on the content server 112, or by any combination of modules, components, and computing devices. According to some embodiments, the routine 400 is performed by the trim job module 214 on a configurable periodic basis, such as daily or weekly. In other embodiments, the trim job module 214 performs the routine 400 every time one or more content items are added to the preservation storage area 212, as may be the case when items are moved to the preservation storage area 212 in batches as part of a purge process of email messages marked for deletion by an end-user of an email mailbox, for example. In further embodiments, the routine 400 may be additionally or alternatively performed by the trim job module 214 in conjunction with existing archive and/or purge processes in the content server 112, such as a periodic archiving or purging process of an email server.

The routine 400 begins at operation 402, where the trim job module 214 executes a query against the content items 108 stored in the preservation storage area 212 to locate the items to be removed, or “trimmed.” According to embodiments, the executed query is built from the filter specification 122 for any active hold specifications related to the content source 110. As described above, the filter specification 122 may include one or more keywords or a search expression for filtering the content items 108. The filter specification 122 may also include a date-range for filtering email messages by date sent or received, documents by created or modified date, and the like. The trim job module 214 may utilize the indexing and searching facilities provided by the content server 112 to execute the query against the content items 108 in the preservation storage area 212, for example.

According to one embodiment, the trim job module 214 executes a query comprising a negation of the filter specification 122. For example, if the filter specification 122 specifies the keywords “CAT” and “DOG” or the search expression “CAT OR DOG,” then the trim job module 214 may execute a query comprising “NOT CAT AND NOT DOG” against the content items 108 in the preservation storage area 212 in order to locate the items to remove. Utilizing the negative of the filter specification 122 to query the content items 108 has the advantage that items that cannot be indexed and searched, such as encrypted or compressed items or items stored in a proprietary format, will remain in the preservation storage area 212 for later retrieval and review by appropriate personnel.

In other embodiments, the trim job module may execute a query built directly from the filter specification 122, and then identify those content items 108 in the preservation storage area 212 not returned by the query as candidates for removal. It will be appreciated that if multiple holds are in effect for the content source 110, i.e. multiple hold specifications 204 related to the content source exist, then the trim job module 214 may combine the filter specifications 122 from the active hold specifications 204 using known methods to build the query to be executed against the content items 108 stored in the preservation storage area 212 in order to locate the items for removal.

The routine 400 proceeds from operation 402 to operation 404, where the trim job module 214 removes those content items 108 from the preservation storage area 212 that do not match the filter specification(s) 122 that were located in operation 402. As described above, content items 108 that cannot be indexed and searched, such as encrypted or compressed items or items stored in a proprietary format, may not be removed from the preservation storage area 212 by the trim job module 214 so that these content items may be retrieved and reviewed by appropriate personnel at a later time. From operation 404, the routine 400 ends.

According to further embodiments, the trim job module 214 may further clean up content items 108 that were placed in the preservation storage area 212 based on expired holds, i.e. hold specifications 204 that have an expiration date 210 that has passed. The trim job module 214 may also remove the preservation storage area 212 if it is determined that no active holds related to the content source 110 exist. In alternative embodiments, the hold manager module 202 may copy all content items 108 in the content source 110 or higher level storage container to the preservation storage area 212 at the time the preservation request is received, i.e. when a hold specification 204 is created for the content source. In one embodiment, the content items 108 copied to the preservation storage area 212 may be limited based on the preservation date 208. The trim job module 214 may then be executed to cleanup those items not matching any specified filter specification(s) 122 for the related hold specification(s) 204.

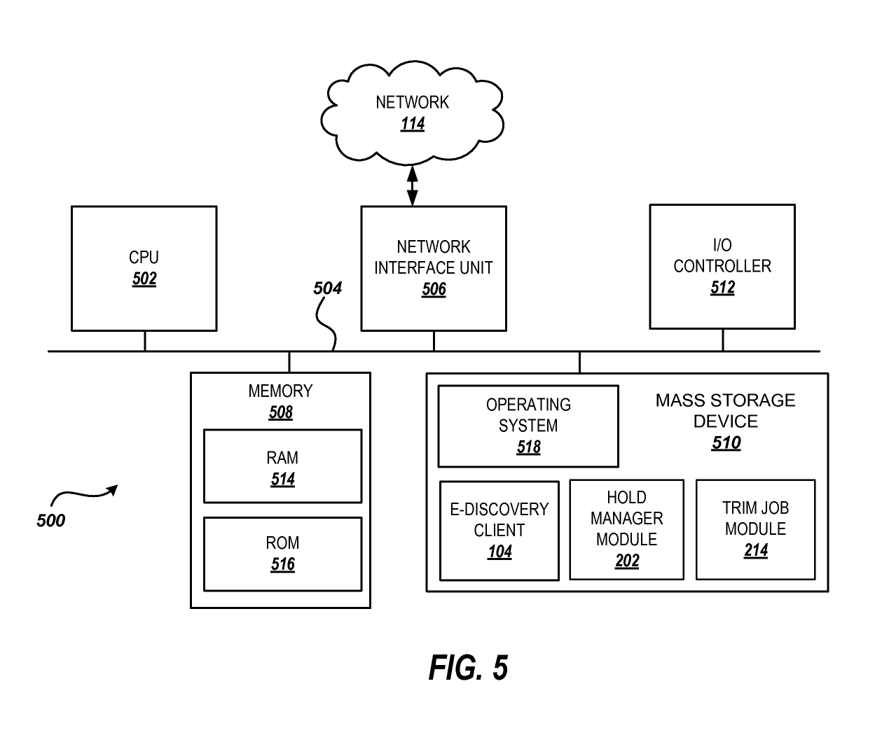

FIG. 5 shows an example computer architecture for a computer 500 capable of executing the software components described herein for providing efficient in-place preservation of content in multiple, disparate content sources without disrupting end-users' access to the content or content sources, in the manner presented above. The computer architecture shown in FIG. 5 illustrates a server computer, a conventional desktop computer, laptop, notebook, tablet, PDA, wireless phone, or other computing device, and may be utilized to execute any aspects of the software components presented herein described as executing on the content server 112, the computer system 102, and/or other computing devices.

The computer 500 includes one or more central processing units (“CPUs”) 502. The CPUs 502 may be standard processors that perform the arithmetic and logical operations necessary for the operation of the computer 500. The CPUs 502 perform the necessary operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and other logic elements.

The computer architecture further includes a system memory 508, including a random access memory (“RAM”) 514 and a read-only memory (“ROM”) 516, and a system bus 504 that couples the memory to the CPUs 502. A basic input/output system containing the basic routines that help to transfer information between elements within the computer 500, such as during startup, is stored in the ROM 516. The computer 500 also includes a mass storage device 510 for storing an operating system 518, application programs, and other program modules, which are described in greater detail herein.

The mass storage device 510 is connected to the CPUs 502 through a mass storage controller (not shown) connected to the bus 504. The mass storage device 510 provides non-volatile storage for the computer 500. The computer 500 may store information on the mass storage device 510 by transforming the physical state of the device to reflect the information being stored. The specific transformation of physical state may depend on various factors, in different implementations of this description. Examples of such factors may include, but are not limited to, the technology used to implement the mass storage device, whether the mass storage device is characterized as primary or secondary storage, and the like.

For example, the computer 500 may store information to the mass storage device 510 by issuing instructions to the mass storage controller to alter the magnetic characteristics of a particular location within a magnetic disk drive, the reflective or refractive characteristics of a particular location in an optical storage device, or the electrical characteristics of a particular capacitor, transistor, or other discrete component in a solid-state storage device. Other transformations of physical media are possible without departing from the scope and spirit of the present description. The computer 500 may further read information from the mass storage device 510 by detecting the physical states or characteristics of one or more particular locations within the mass storage device.

As mentioned briefly above, a number of program modules and data files may be stored in the mass storage device 510 and RAM 514 of the computer 500, including an operating system 518 suitable for controlling the operation of a computer. The mass storage device 510 and RAM 514 may also store one or more program modules. In particular, the mass storage device 510 and the RAM 514 may store the e-discovery client 104, the hold manager module 202, and/or the trim job module 214, each of which was described in detail above in regard to FIGS. 1 and 2. The mass storage device 510 and the RAM 514 may also store other types of program modules or data.

In addition to the mass storage device 510 described above, the computer 500 may have access to other computer-readable media to store and retrieve information, such as program modules, data structures, or other data. It will be appreciated by those skilled in the art that computer-readable media may be any available media that can be accessed by the computer 500, including computer-readable storage media and communications media. Communications media includes transitory signals. Computer-readable storage media includes volatile and non-volatile, removable and non-removable media implemented in any method or technology for the non-transitory storage of information, such as computer-readable instructions, data structures, program modules, or other data. For example, computer-readable storage media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and that can be accessed by the computer 500.

The computer-readable storage medium may be encoded with computer-executable instructions that, when loaded into the computer 500, may transform the computer system from a general-purpose computing system into a special-purpose computer capable of implementing the embodiments described herein. The computer-executable instructions may be encoded on the computer-readable storage medium by altering the electrical, optical, magnetic, or other physical characteristics of particular locations within the media. These computer-executable instructions transform the computer 500 by specifying how the CPUs 502 transition between states, as described above. According to one embodiment, the computer 500 may have access to computer-readable storage media storing computer-executable instructions that, when executed by the computer, perform the routines 300 and 400 for providing efficient in-place preservation of content in multiple, disparate content sources without disrupting end-users' access to the content or content sources, described above in regard to FIGS. 3 and 4.

According to various embodiments, the computer 500 may operate in a networked environment using logical connections to remote computing devices and computer systems through one or more networks, such as the network 114. The network 114 may include a LAN, a WAN, the Internet, or a combination of these and any networking topology known in the art. The computer 500 may connect to the network 114 through a network interface unit 506 connected to the bus 504. It should be appreciated that the network interface unit 506 may also be utilized to connect to other types of networks and remote computer systems.

The computer 500 may also include an input/output controller 512 for receiving and processing input from a number of input devices, including a touchscreen, a keyboard, a mouse, a touchpad, an electronic stylus, or other type of input device. Similarly, the input/output controller 512 may provide output to a display device, such as a computer monitor, a flat-panel display, a digital projector, a printer, a plotter, or other type of output device. It will be appreciated that the computer 500 may not include all of the components shown in FIG. 5, may include other components that are not explicitly shown in FIG. 5, or may utilize an architecture completely different than that shown in FIG. 5.

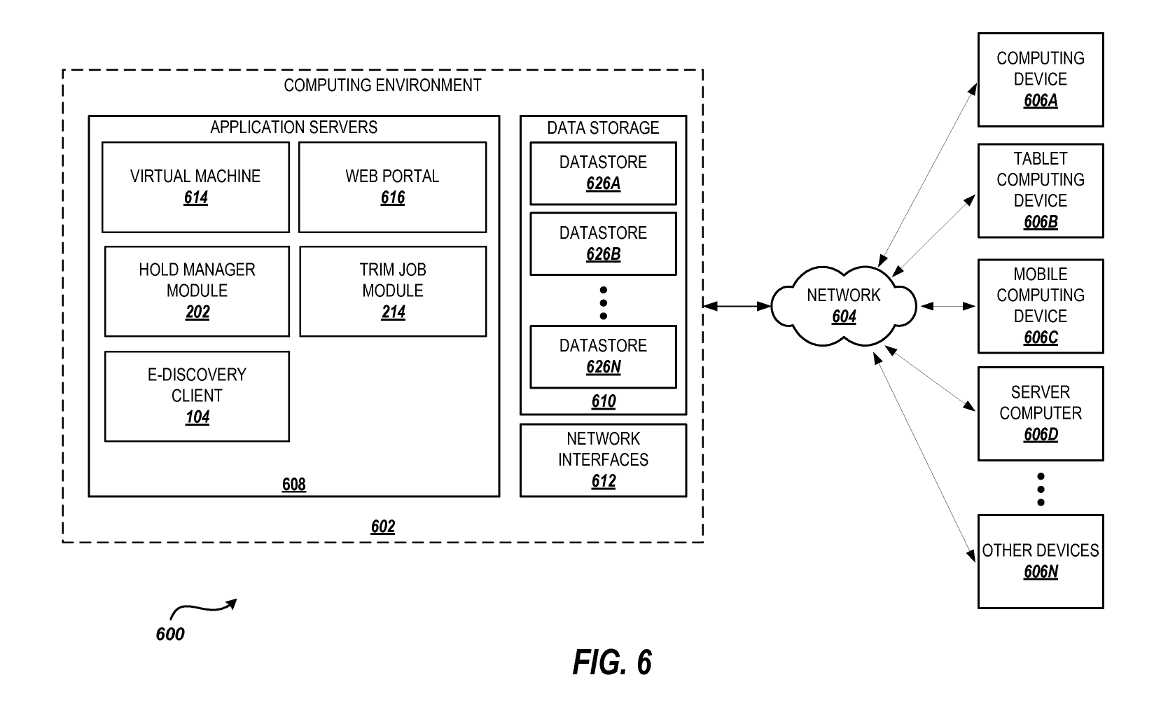

FIG. 6 illustrates an illustrative distributed computing environment 600 capable of executing the software components described herein for providing efficient in-place preservation of content in multiple, disparate content sources without disrupting end-users' access to the content or content sources, in the manner presented above. The distributed computing environment 600 illustrated in FIG. 6 can be used to provide the functionality described herein with respect to the content server 112, the computer system 102, and/or any other computing devices. The distributed computing environment 600 thus may be utilized to execute any aspects of the software components presented herein.

According to various implementations, the distributed computing environment 600 includes a computing environment 602 operating on, in communication with, or as part of a network 604. The network 604 also can include various access networks. One or more client devices 606A-606N (hereinafter referred to collectively and/or generically as “clients 606”) can communicate with the computing environment 602 via the network 604 and/or other connections (not illustrated in FIG. 6). In the illustrated embodiment, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. It should be understood that the illustrated clients 606 and computing architectures illustrated and described herein are illustrative, and should not be construed as being limited in any way.

In the illustrated embodiment, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated embodiment, the application servers 608 host one or more virtual machines 614 for hosting applications or other functionality. According to various implementations, the virtual machines 614 host one or more applications and/or software modules for providing the functionality described herein. It should be understood that this embodiment is illustrative, and should not be construed as being limiting in any way. The application servers 608 also host or provide access to one or more Web portals, link pages, Web sites, and/or other information (“Web portals”) 616.

As shown in FIG. 6, the application servers 608 also can host other services, applications, portals, and/or other resources. For example, the application servers 608 may host the e-discovery client 104, the hold manager module 202, and/or the trim job module 214, each of which was described in detail above in regard to FIGS. 1 and 2. As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual datastores 626A-626N (hereinafter referred to collectively and/or generically as “datastores 626”). The datastores 626 are configured to host data used or created by the application servers 608 and/or other data.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 600 to utilize the functionality described herein for providing efficient in-place preservation of content in multiple, disparate content sources without disrupting end-users' access to the content or content sources.

Based on the foregoing, it should be appreciated that technologies for providing efficient in-place preservation of content in multiple, disparate content sources without disrupting end-users' access to the content or content sources are provided herein. Although the subject matter presented herein has been described in language specific to computer structural features, methodological acts, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A system for providing in-place preservation of content items in a content source, the system comprising:
one or more processors;
a memory coupled to the one or more processors;
a hold manager module residing in the memory and comprising computer-executable instructions that, when executed by the one or more processors, cause the system to
detect that a content item in the content source has been modified or deleted,
upon detecting that the content item has been modified or deleted, determine whether a hold is in effect for the content source,
upon determining that the hold is in effect for the content source, determine whether the content item has been deleted or modified,
upon determining that the content item has been deleted, place a current version of the content item in a preservation storage area,
upon determining that the content item has been modified, determine whether a modified date of the current version of the content item is less than or equal to a preservation date associated with the hold, and
upon determining that the modified date of the current version of the content item is less than or equal to the preservation date, place the current version of the content item in the preservation storage area; and
a trim job module residing in the memory and comprising computer-executable instructions that, when executed by the one or more processors, cause the system to
locate one or more content items in the preservation storage area that do not match a filter specification associated with the hold, and
upon locating the one or more content items in the preservation storage area that do not match the filter specification, remove the one or more content items from the preservation storage area.

2. The system of claim 1, wherein the preservation storage area comprises a hidden area of the content source.

3. The system of claim 1, wherein the locate and remove operations are performed by the trim job module on a periodic basis.

4. The system of claim 1, wherein a plurality of holds are in effect for the content source and wherein the trim job locates the one or more content items in the preservation storage area that do not match any filter specification associated with each of the plurality of holds.

5. A computer-implemented method for performing in-place preservation of content items, the method comprising:
receiving a preservation request at a content server, the preservation request comprising a specification of a content source and a filter specification;
creating in the content server a hold specification related to the content source;
detecting that a content item in the content source has been modified or deleted;
upon detecting that the content item has been modified or deleted, placing a current version of the content item in a preservation storage area, wherein the preservation storage area comprises a hidden area in the content source; and
periodically removing one or more content items from the preservation storage area that do not match the filter specification.

6. The computer-implemented method of claim 5, wherein the hold specification further comprises a preservation date, and wherein the method further comprises:
upon detecting that the content item has been modified or deleted, determining whether the content item has been deleted or modified;
upon determining that the content item has been modified, determining whether a modified date of the current version of the content item is less than or equal to the preservation date;
upon determining that the modified date of the current version of the content item is less than or equal to the preservation date, placing the current version of the content item in the preservation storage area; and
upon determining that the modified date of the current version of the content item is not less than or equal to the preservation date, not placing the current version of the content item in the preservation storage area.

7. The computer-implemented method of claim 5, wherein the preservation request comprises a plurality of specifications of content sources.

8. The computer-implemented method of claim 5, wherein the filter specification comprises one or more keywords.

9. The computer-implemented method of claim 5, wherein a plurality of hold specifications related to the content source exist, and wherein periodically removing the one or more content items from the preservation storage area comprises removing one or more content items from the preservation storage area that do not match any filter specification comprising each of the plurality of hold specifications.

10. The computer-implemented method of claim 5, wherein the content server comprises an email server and the content source comprises an email mailbox.

11. The computer-implemented method of claim 5, wherein the content server comprises a content site server and the content source comprises a document library.

12. The computer-implemented method of claim 5, wherein the preservation request is received at a plurality of content servers, the preservation request comprising a specification of one or more content sources hosted by each of the plurality of content servers.

13. A computer-readable storage medium encoded with computer-executable instructions that, when executed by a computer, cause the computer to:
receive a preservation request comprising a specification of a content source;
create a hold specification related to the content source;
detect that a content item in the content source has been modified or deleted; and
upon detecting that the content item has been modified or deleted, place a current version of the content item in a preservation storage area.

14. The computer-readable storage medium of claim 13, wherein the preservation storage area comprises an area of the content source.

15. The computer-readable storage medium of claim 13, wherein the preservation request further comprises a filter specification, and wherein the computer-readable storage medium is encoded with additional computer-executable instructions that cause the computer to periodically remove one or more content items from the preservation storage area that do not match the filter specification.

16. The computer-readable storage medium of claim 13, wherein the preservation request further comprises a filter specification, and wherein the current version of the content item is placed in the preservation storage area only if the content item matches the filter specification.

17. The computer-readable storage medium of claim 13, wherein one or more prior versions of the content item are placed in the preservation storage area along with the current version of the content item.

18. The computer-readable storage medium of claim 13, wherein the preservation request further comprises a preservation date, and wherein the current version of the content item is placed in the preservation storage area only if a previous modification to the content item was made before the preservation date.

19. The computer-readable storage medium of claim 18, wherein a plurality of hold specifications related to the content source exist, each hold specification having a different preservation date.

20. The computer-readable storage medium of claim 13, encoded with additional computer-executable instructions that cause the computer to, upon detecting that the content item has been modified or deleted, place an entire container containing the content item in the preservation storage area.
